(19) United States
(12) Patent Application Publication
(10) Pub. No.: US 2020/0233162 A1
(43) Pub. Date: Jul. 23, 2020

(54) QUAD SMALL FORM FACTOR-DOUBLE DENSITY PLUGGABLE (QSFP-DD) TRANSCEIVER MODULE WITH HEAT SINK

(71) Applicant: Molex, LLC, Lisle, IL (US)

(72) Inventor: Shiping YU, Carlsbad, CA (US)

(73) Assignee: Molex, LLC, Lisle, IL (US)

(21) Appl. No.: 16/745,336

(22) Filed: Jan. 17, 2020

Related U.S. Application Data
(60) Provisional application No. 62/794,724, filed on Jan. 21, 2019.

(51) Int. Cl. G02B 6/42

(52) U.S. Cl. CPC G02B 6/4269; G02B 6/4278

(57) ABSTRACT

A Quad Small Form Factor-Double Density Pluggable (QSFP-DD) transceiver module which complies with the accepted specifications of the Quad Small Form Factor Pluggable Double Density (QSFP-DD) Multi Source Agreement (MSA) group has a body, a paddle card mounted in the body, and a plurality of conductive fins extending upwardly from top and bottom walls of the body. The QSFP-DD transceiver module is insertable into a cage and is configured to mate with mating connector in the cage and with a fiber optic cable. The conductive fins do not seat within the cage. The conductive fins dissipate heat generated by convection.

### RELATED APPLICATIONS

This application claims priority to U.S Provisional Application 62/794,724, filed on Jan. 21, 2019, which is incorporated herein by reference in its entirety.

### TECHNICAL FIELD

This disclosure relates to the field of input/output (IO) connectors, more specifically to a pluggable transceiver module in the form of a Quad Small Form Factor-Double Density Pluggable (QSFP-DD) transceiver module suitable for use in high data rate applications.

### DESCRIPTION OF RELATED ART

Input/output (I/O) connectors are commonly used in applications where high bandwidth is desired and are commonly used to provide connectivity between boxes or racks of computers, routers and switches. One such commonly used format of an I/O connector is a Quad Small Form Factor-Double Density Pluggable (QSFP-DD) connector. This connector includes a transceiver module and a cage that is defined by standard bodies and such that reliable performance is provided regardless of the vendor.

As data rates have increased, one issue that has been difficult to overcome is the physical limitation of medium that is used to transmit signals. Passive cables, for example, are cost effective for shorter distances but tend to be limited with respect to distance as signal frequencies increase. Active copper and fiber optic cables are well suited to transmit signals over longer distances but require power and thus tend to create thermal issues if the connector system is not properly designed. One of the major issues with the increased use of active cables assemblies, however, is the increased thermal burden the use of such cable assemblies place on the connector system. Attempting to cool a Quad Small Form Factor-Double Density Pluggable (QSFP-DD) transceiver module that is placed inside a cage is relatively challenging. Thus, certain individuals would appreciate an improvement to thermal management.

Quad Small Form Factor-Double Density Pluggable (QSFP-DD) transceiver modules are made within the outline specification of the Quad Small Form Factor Pluggable Double Density (QSFP-DD) Multi Source Agreement (MSA) group which has been adopted by manufacturers. Thus, there are exact standards that must be complied with for manufacturing QSFP-DD) transceiver modules.

### SUMMARY

A Quad Small Form Factor-Double Density Pluggable (QSFP-DD) transceiver module which complies with the accepted specifications of the Quad Small Form Factor Pluggable Double Density (QSFP-DD) Multi Source Agreement (MSA) group includes a body, a paddle card mounted in the body, and a plurality of conductive fins extending upwardly from top and bottom walls of the body. The QSFP-DD transceiver module is insertable into a cage and is configured to mate with mating connector in the cage and with a fiber optic cable. The conductive fins do not seat within the cage. The conductive fins dissipate heat generated by the electronics and optics mounted within QSFP-DD transceiver module by convection.

### BRIEF DESCRIPTION OF THE DRAWINGS

The present invention is illustrated by way of example and not limited in the accompanying figures in which like reference numerals indicate similar elements and in which:

FIG. 1 is a top perspective view of an embodiment of an input/output (I/O) connector which includes a conductive cage into which a pair of Quad Small Form Factor-Double Density Pluggable (QSFP-DD) transceiver modules are inserted;

FIG. 2 is a top perspective view of the conductive cage;

FIG. 3 is a top perspective view of one of the QSFP-DD transceiver modules;

FIG. 4 is a top plan view of the QSFP-DD transceiver module of FIG. 3;

FIG. 5 is a bottom perspective view of the QSFP-DD transceiver module of FIG. 3;

FIG. 6 is a bottom plan view of the QSFP-DD transceiver module of FIG. 3; and

FIG. 7 is a side elevation view of the QSFP-DD transceiver module of FIG. 3.

### DETAILED DESCRIPTION OF THE PREFERRED EMBODIMENTS

The detailed description that follows describes exemplary embodiments and the features disclosed are not intended to be limited to the expressly disclosed combination(s). Therefore, unless otherwise noted, features disclosed herein may be combined together to form additional combinations that were not otherwise shown for purposes of brevity.

An input/output (I/O) connector 20 includes a conductive cage 22 into which a Quad Small Form Factor-Double Density Pluggable (QSFP-DD) transceiver module 24 is inserted. The QSFP-DD transceiver module 24 forms a primary electromagnetic containment and the cage 22 forms a conductive sleeve around the QSFP-DD transceiver module 24. The cage 22 and the QSFP-DD transceiver module 24 form a telescoping assembly that can contain a mating connector (not shown) toward a distal extent of the connector 20. The QSFP-DD transceiver module 24 receives a fiber optic cable (not shown).

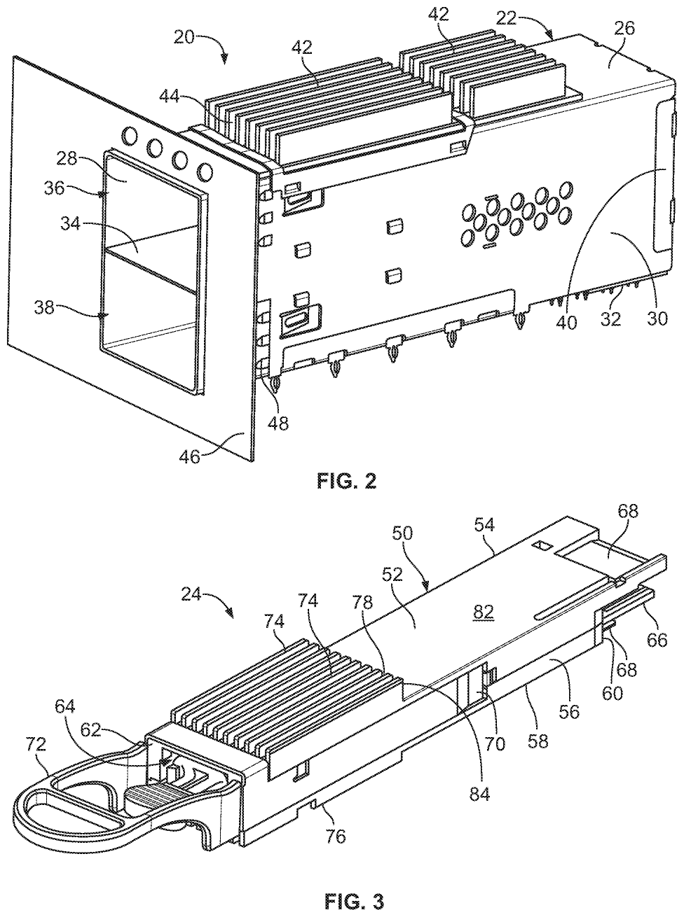

As shown in FIG. 2, the cage 22 includes an upper wall 26, side walls 28, 30 extending downwardly therefrom at opposite side edges thereof to a lower wall 32, and an intermediate wall 34 extending between the side walls 28, 30. The walls 26, 28, 30, 32, 34 form an upper port 36 above the intermediate wall 34 and a lower port 38 below the intermediate wall 34. If desired, the intermediate wall 34 can have a heat sink (not shown) mounted therein. The cage 22 may rest on a printed circuit board (not shown). The cage 22 may be formed by stamping and forming. A rear panel 40 may be attached to a rear end of the cage 22. The cage 22 is thermally conductive and forms a shield assembly for the components mounted therein.

A plurality of conductive fins 42 extend upwardly from an upper surface of the upper wall 26 and are arranged to conduct heat away from the cage 22 and dissipate heat by convection. In an embodiment as shown in the drawings, the fins 42 are elongated such that elongated channels 44 are formed therebetween. In an alternative embodiment (not shown), the fins 42 are formed in an array of pillars.

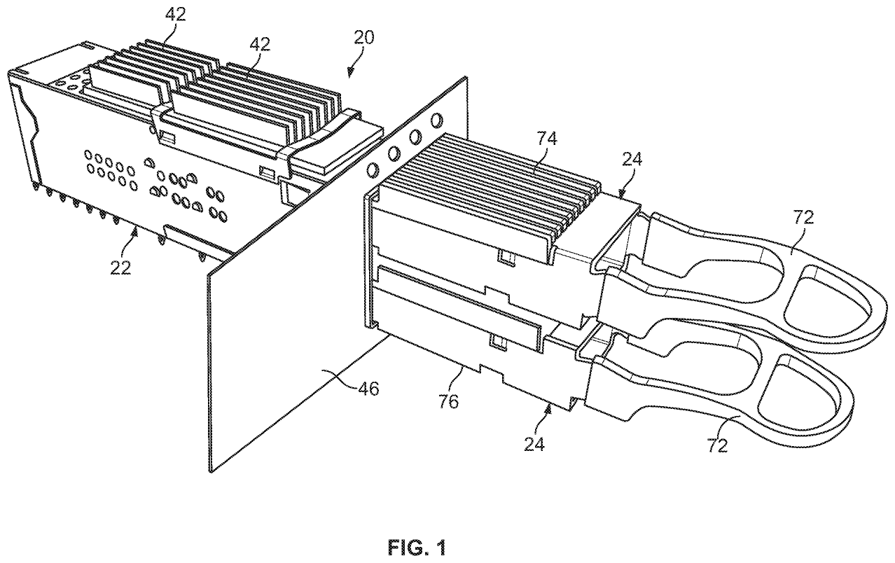

As shown in FIG. 1, a first QSFP-DD transceiver module 24 is inserted into the upper port 36 and has a portion which is shaped to seat within the upper port 36 so that the QSFP-DD transceiver module 24 can mate with the mating connector within the cage 22. A second QSFP-DD transceiver module 24 is inserted into the lower port 38 and has a portion which is shaped to seat within the lower port 38 so that the QSFP-DD transceiver module 24 can mate with the mating connector within the cage 22.

In an example, the mating connectors (not shown) include a plurality of wafers arranged in a side-by-side arrangement and supported by an insulative frame. The mating connectors are shaped to seat within the upper and lower ports 36, 38 of the cage 22 so that the QSFP-DD transceiver modules 24 can mate therewith. While the cage 22 is shown with two ports 36, 38, only a single port may be provided or more than two ports may be provided, such that an array of ports are provided.

The cage 22 is engaged with a chassis 46 that mates with the front end of the cage 22. The cage 22 may have spring fingers 48 provided therein to assist in the mating of the cage 22 and the chassis 46.

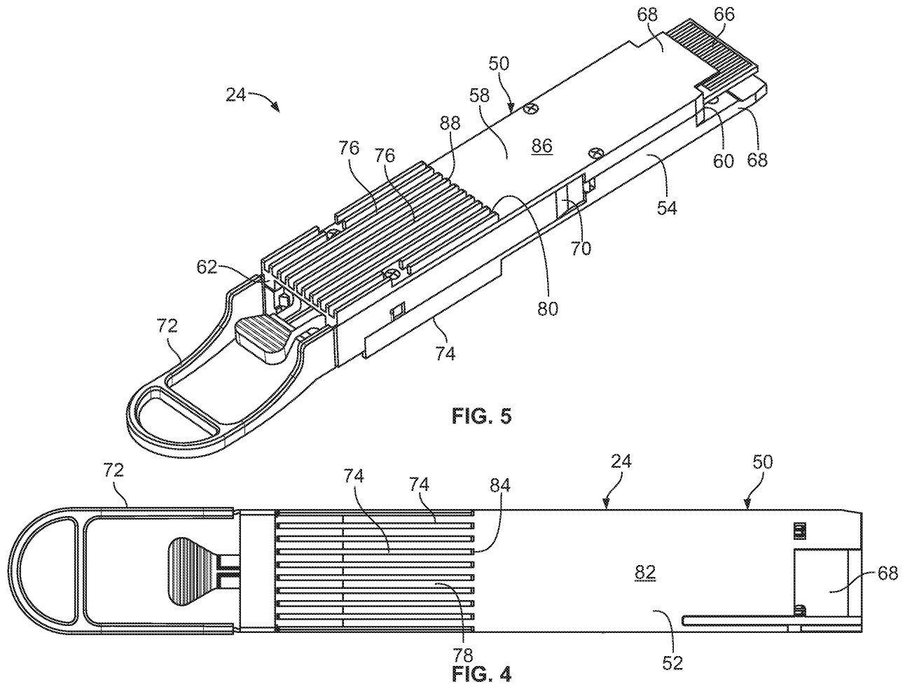

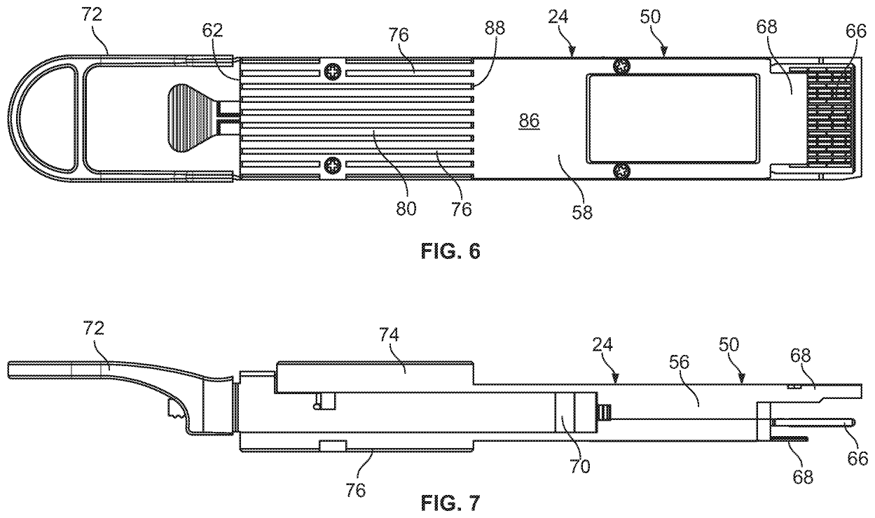

As shown in FIGS. 3-7, each QSFP-DD transceiver module 24 includes a body 50 formed from a thermally conductive material and having a top wall 52, side walls 54, 56 depending downwardly from the top wall 52, and a bottom wall 58 connected to bottom ends of the side walls 54, 56. The body 50 defines a front face 60 and an opposite rear face 62 and a passageway 64 that extends therebetween. The rear face 62 defines a cable entrance port into the passageway 64. The body 50 can be formed in a variety of ways, such as, but not limited to, die casting, forming and/or machining.

A paddle card 66 is positioned between the top and bottom walls 52, 58, and can be offset toward the bottom wall 58. The paddle card 66 extends forward of the front face 60. In a double density configuration, the paddle card 66 includes two rows of contact pads positioned adjacent each other along a mating direction. One or more flanges 68 can extend forward from the front face 60 and can help provide protection for the paddle card 66. The wafers of the mating connector include two rows of terminals spaced along the mating direction, each of which engage respective contact pads formed on the paddle card 66. Each row of contacts includes terminals that engage contact pads on a top and bottom side of the paddle card 66.

A lock 70 and release tab 72 are provided to lock the QSFP-DD transceiver module 24 to the cage 22. The release tab 72, which may be generally U-shaped having two arms intersecting at a top, curved cross-member, is attached to the lock 70 and extends out from the rear face 62 proximate to the cable entrance port into the passageway 64. The release tab 72 provides an accessible surface to be grasped by a user to facilitate insertion of the QSFP-DD transceiver module 24 into the cage 22 when the user applies a pushing force, and to facilitate extraction of the QSFP-DD transceiver module 24 from the cage 22 when the user applies a pulling force. The release tab 72 can be made of any suitable material, such as plastic. The release tab 72 can be attached to the lock 70 by any suitable means, including but not limited to overmolding, welding, clipping, and gluing. In an embodiment, the lock 70 is provided in both side walls 54, 56. In other embodiments, the lock 70 is provided on the top wall 52, the bottom wall 58, or some combination. The lock 70 may include a step for catching a latch disposed in the cage 22. When the latch is engaged with the lock 70, the body 50 is sits secured and properly aligned within the cage 22. The lock 70 may be formed as a separate member which is attached to the body 50 by suitable means, such as fasteners, thermally conductive glue or by welding.

The QSFP-DD transceiver module 24 further includes a plurality of fins 74 formed from thermally conductive material and which extend from the top wall 52 of the body 50, and a plurality of fins 76 formed from thermally conductive material and which extend from the bottom wall 58 of the body 50. The fins 74 form an upper heat sink and the fins 76 form a lower heat sink. The fins 74, 76 are arranged to conduct heat generated by the electronics and optics mounted within the passageway 64 to the body 50, and then to fins 74, 76 for dissipation by convection. In an embodiment, the fins 74 are integrally formed with the top wall 52, such as, for example, but not limited to, by die casting, forming and/or machining. In an embodiment, the fins 74 are made separately and are attached to the top wall 52, such as, for example, but not limited to, by conductive adhesives, brazing, soldering, and welding. In an embodiment, the fins 76 are integrally formed with the bottom wall 58, such as, for example, but not limited to, by die casting, forming and/or machining. In an embodiment, the fins 76 are made separately and are attached to the bottom wall 58, such as, for example, but not limited to, by conductive adhesives, brazing, soldering, and welding.

In an embodiment as shown in the drawings, the fins 74, 76 are elongated and extend from the rear face 62 toward the front face 60 such that elongated channels 78, 80 are formed therebetween. As shown, the fins 74 do not extend along the entire length of the top wall 52, such that a planar surface 82 of the top wall 52 is provided between front ends 84 of the fins 74 and the front face 60. Likewise, as shown, the fins 76 do not extend along the entire length of the bottom wall 58, such that a planar surface 86 of the bottom wall 58 is provided between front ends 88 of the fins 76 and the front face 60. The fins 74 may align with the fins 76. In an alternative embodiment (not shown), the fins 74, 76 are formed of an array of fins with intersecting channels creating a pillar-type arrangement.

In an embodiment, the body 50 may have a plurality of walls which form the passageway 64 and the fins 74, 76 can be separately formed from the body 50 and attached to the body 50 by suitable means, such as fasteners, thermally conductive glue or by welding. In this embodiment, the fins 74, 76 may extend from a base plate which is attached to the top and bottom walls 52, 58. The fins 74, 76 may be formed on a sleeve that overlays the body 50, with the exception of the lock 70 so that the sleeve does not interfere with the functioning of the lock 70.

When the QSFP-DD transceiver modules 24 are inserted into the cage 22, the fins 74, 76 do not seat within the ports 36, 38 and instead are outside of the cage 22 as shown in FIG. 1. The planar surfaces 82, 86 seat within the ports 36, 38. The fins 74, 76 extend outwardly from the front end of the cage 22. The fins 74, 76 further dissipate heat from the input/output (I/O) connector 20, in addition to the fins 42 on the cage 22. The fins 74, 76 enhance the cooling of the QSFP-DD transceiver module(s) 24. The fins 74, 76 conduct heat into the surrounding air by convection.

All components of the QSFP-DD transceiver module 24 are made within the existing outline specification of the Quad Small Form Factor Pluggable Double Density (QSFP-DD) Multi Source Agreement (MSA) group, except that the fins 74, 76 of the present disclosure have been added to the existing outline specification of the Quad Small Form Factor Pluggable Double Density (QSFP-DD) Multi Source Agreement (MSA) group to provide additional cooling benefits not previously obtainable under the existing outline specification of the Quad Small Form Factor Pluggable Double Density (QSFP-DD) Multi Source Agreement (MSA) group.

The rear face 62 and the cable entrance port at the rear end of the passageway 64 and can interface with a fiber optic cable (not shown) that connects the QSFP-DD transceiver module 24 to one or more strands of the fiber optic cable.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1. A Quad Small Form Factor-Double Density Pluggable (QSFP-DD) transceiver module comprising:
a conductive body having a top wall, a bottom wall and side walls extending between the top and bottom walls, a passageway extending from a rear face of the body to a front face of the body, the passageway defining a cable entrance port;
a paddle card mounted in the body and extending from the front face;
a plurality of conductive fins extending upwardly from the top wall of the body and extending along a portion of the top wall between the front face and the rear face; and
a plurality of conductive fins extending downwardly from the bottom wall of the body and extending along a portion of the top wall between the front face and the rear face.

2. The QSFP-DD transceiver module of claim 1, wherein the fins are elongated and define channels between adjacent fins.

3. The QSFP-DD transceiver module of claim 1, wherein the body has a lock thereon which is configured to engage with a mating cage.

4. The QSFP-DD transceiver module of claim 3, wherein the lock is provided on the side walls of the body.

5. The QSFP-DD transceiver module of claim 3, further comprising a release tab attached to the lock.

6. An input/output connector comprising:
a conductive cage having an upper wall, a lower wall and side walls extending between the upper and lower walls, the walls forming a port therein, and a plurality of conductive fins extending from the upper wall; and
a Quad Small Form Factor-Double Density Pluggable (QSFP-DD) transceiver module comprising a conductive body having a top wall, a bottom wall and side walls extending between the top and bottom walls, a passageway extending from a rear face of the body to a front face of the body, the passageway defining a cable entrance port at the rear face, a paddle card mounted in the body and extending from the front face, a plurality of conductive fins extending upwardly from the top wall of the body and extending along a portion of the top wall between the front face and the rear face, and a plurality of conductive fins extending downwardly from the bottom wall of the body and extending along a portion of the top wall between the front face and the rear face,
wherein when the QSFP-DD transceiver module is seated within the cage, the fins on the QSFP-DD transceiver module do not seat within the port of the cage.

7. The input/output connector of claim 6, wherein the fins on the QSFP-DD transceiver module are elongated and define channels between adjacent fins.

8. The input/output connector of claim 7, wherein the fins on the cage are elongated and define channels between adjacent fins.

9. The input/output connector of claim 6, wherein the body has a lock thereon which is configured to engage with the cage.

10. The input/output connector of claim 9, wherein the lock is provided on the side walls of the body.

11. The input/output connector of claim 9, further comprising a release tab attached to the lock.

12. The input/output connector of claim 6, further comprising a chassis attached to the cage.
